(19) United States
(12) Patent Application Publication
(10) Pub. No.: US 2007/0163729 A1
(43) Pub. Date: Jul. 19, 2007

(54) Support bracket assembly for the headrail of window blinds

(75) Inventors: Wen Ying Liang, Changhua Hsien (TW); Chao Cheng Su, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/331,134

(22) Filed: Jan. 13, 2006

(51) Int. Cl. E06B 9/00

(52) U.S. Cl. 160/178.1 R

(57) ABSTRACT

A support bracket assembly for the headrail of window blinds comprises a support bracket and a clamping body wherein the support bracket has a vertical abutment surface made up of a slant-cut facet, guide recesses and stop ends, and a horizontal abutment surface composed of a retaining board, support plates, and an accommodation space. The clamping body has multiple oblique guide blocks of different thickness, a limiting slot and symmetrical pivoting guide plates extending vertically at one side of the top surface thereon, and a clamping board protruding horizontally at the other side thereof. Via the aforementioned structure, the clamping body assembled onto the support bracket thereof can be obliquely adjusted up/down and moved forwards/backwards along the support bracket to fit to headrails of different sizes for stable location thereof, expanding the range of application and achieving the best using state thereof.

### BACKGROUND OF THE INVENTION

The present invention is related to a support bracket assembly for the headrail of window blinds, comprising a support bracket and a clamping body wherein guide recesses of the support bracket are matched to pivoting guide plates of the clamping body, and a locking element is registered with a limiting slot of the clamping body. And via the design of a slant-cut facet of the support bracket cooperatively matched to oblique guide blocks of the clamping body thereof, the clamping body can be moved along the support bracket and appropriately adjusted upwards/downwards and forwards/backwards to fit to headrails of different sizes for stable location of the headrails, flexibly expanding the range and achieving the best state of application thereof.

Please refer to FIG. 1 showing an exploded perspective view of a conventional support bracket assembly for the headrail of window blinds. The conventional support bracket is made up of a support bracket 10 and a clamping means 20 wherein the support bracket 10, made in an inverted L-shaped configuration, comprises a horizontal abutment surface 11 and a vertical abutment surface 12. The horizontal abutment surface 11 has a plurality of stop ribs 111 extending at one lateral side of the inner wall to separate multiple clearance grooves 112 each having a vertical fixing hole 115 disposed therein. One side of the stop ribs 111 corresponding to the inner wall of the vertical abutment surface 12 is preset an inverted U-shaped accommodation space 113, and the other side of the stop ribs 111 thereof has a retaining plate 114 extending horizontally outwards. The vertical abutment surface 12 has an assembly hole 121 extending upwards in the middle section of the bottom edge, and a set of clearance cavities 122 each having a transverse fixing hole 123 disposed at both lateral sides of the inner wall thereof. The clamping means 20 is composed of a locking thru-hole 21 disposed at one side thereof, and a support section 22 extending upwards at the other side to form an L-shaped configuration thereby.

Please refer to FIG. 2. In assembly, the support bracket 10 is mounted to a wall surface via screws applied to the horizontal abutment surface 11 and the vertical abutment surface 12 of the support bracket 10 and concealed inside the clearance grooves and cavities 112, 122 thereof respectively. A headrail 30 is then tilted to one side, permitting the retaining plate 114 of the support bracket 10 to mount into a receiving groove 31 of the headrail 30. The headrail 30 is supported by a hand to prevent a conjoining portion 32 disposed at the other side of the headrail 30 from falling down from the accommodation space 113 due to the gravity force. And the headrail is pushed to the other side to locate the conjoining portion 32 precisely into the accommodation space 113 thereof. Meanwhile, the headrail 30 is continuously held from the bottom by a hand while a screw is mounted to the locking thru-hole 21 of the clamping means 20 and secured by force to the assembly hole 121 of the vertical abutment surface 12. The support section 22 of the clamping means 20 is then adjusted in position under the headrail 30 and screwed up to clamp tight the same side of the conjoining portion 32 thereof simultaneously abutting close against the accommodation space 113 and the inner wall of the vertical abutment surface 12 to achieve location of the headrail 30 thereby.

There are some drawbacks to such conventional support bracket assembly for the headrail of window blinds. First, before the clamping means 20 is secured to the support bracket 10 for location, one conjoining portion 32 disposed at one side of the headrail 30 is not held in a suspended state. To prevent it from tilting downwards at one side and detaching from the accommodation space 113, the headrail 30 must be supported by one hand, while the clamping means 20 is locked up to the headrail 30 by the other hand, which makes the assembly thereof rather difficult and time-consuming to operate. Second, the clamping means 20 is molded in a plate-like configuration, and only the support section 22 thereof is applied to clamp tight the conjoining portion 32 disposed at one side of the headrail 30 while the conjoining portion 32 disposed at the other side is simply hanged without any support, which makes the headrail 30 rather unstably sustained in assembly.

### SUMMARY OF THE PRESENT INVENTION

It is, therefore, the primary purpose of the present invention to provide a support bracket assembly for the headrail of window blinds, comprising a support bracket and a clamping body wherein guide recesses of the support bracket are matched to pivoting guide plates of the clamping body, and a locking element is registered with a limiting slot of the clamping body. And via the design of a slant-cut facet of the support bracket cooperatively matched to oblique guide blocks of the clamping body thereof, the support bracket assembly can be appropriately adjusted upwards/downwards and forwards/backwards to fit to headrails of different sizes for stable location of the headrails, flexibly expanding the range of application and boosting the versatility thereof.

It is, therefore, the second purpose of the present invention to provide a support bracket assembly for the headrail of window blinds wherein a retaining board and multiple support plates of the support bracket offer precise support for the location and suspension of conjoining portions disposed at both longitudinal sides of the headrails thereon without the use of manual support by hands to avoid the inconvenience of the above-mentioned prior art and allow an easier assembly of the clamping body onto the support bracket thereof, efficiently achieving the best state of application.

It is, therefore, the third purpose of the present invention to provide a support bracket assembly for the headrail of window blinds wherein via the guide recesses matched to the pivoting guide plates, and the slant-cut facet fitting to oblique guide blocks thereof as well as stop ends of the support bracket corresponding to stop planes of the clamping body thereof, the clamping body can be appropriately moved upwards/downwards and forwards/backwards or obliquely slid along the support bracket for adjustment to fit the support bracket assembly to headrails of different sizes, economically reduce the cost of mold-casting of the conventional support bracket assembly to achieve the economical efficiency and make the present invention more competitive on the market.

### BRIEF DESCRIPTION OF THE DRAWINGS

FIG. 1 is an exploded perspective view of a conventional support bracket assembly for the headrail of window blinds.

FIG. 2 is a diagram showing the assembling operation of the conventional support bracket assembly thereof.

FIG. 3 is another diagram showing the assembling operation of the conventional support bracket assembly thereof.

FIG. 4 is an exploded perspective view of the present invention.

FIG. 5 is an exploded and partially enlarged view of the present invention.

FIG. 6 is a diagram showing the assembling operation of the present invention.

FIG. 7 is another diagram showing the assembling operation of the present invention.

FIG. 8 is a cross sectional view of the present invention completed in assembly.

FIG. 9 is a diagram showing the operation of the present invention adjusted upwards/downwards.

FIG. 10 is a diagram showing the operation of the present invention adjusted forwards/backwards.

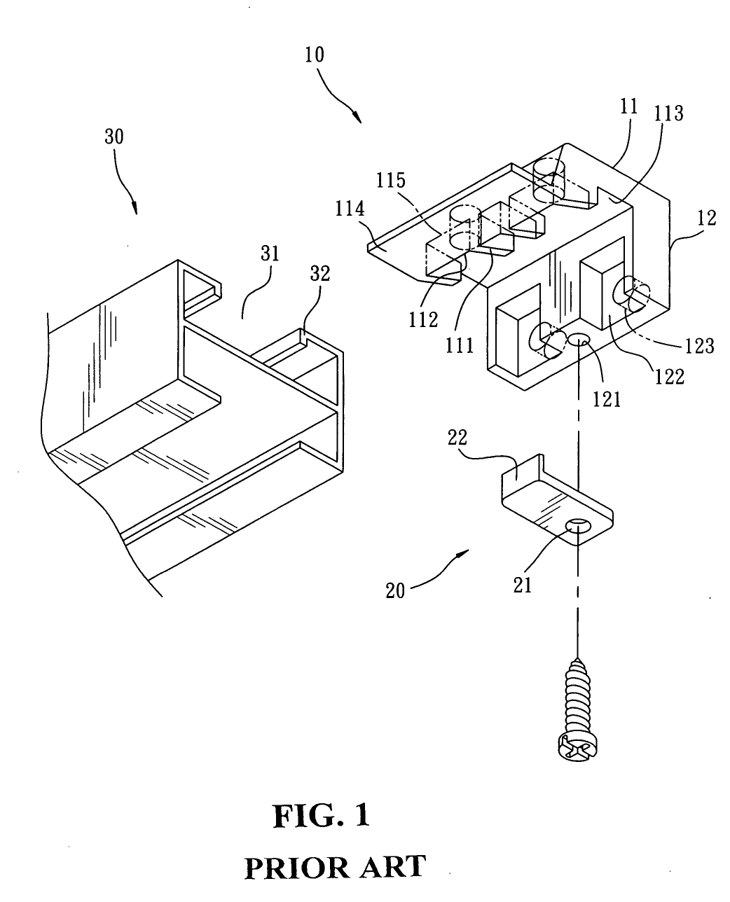

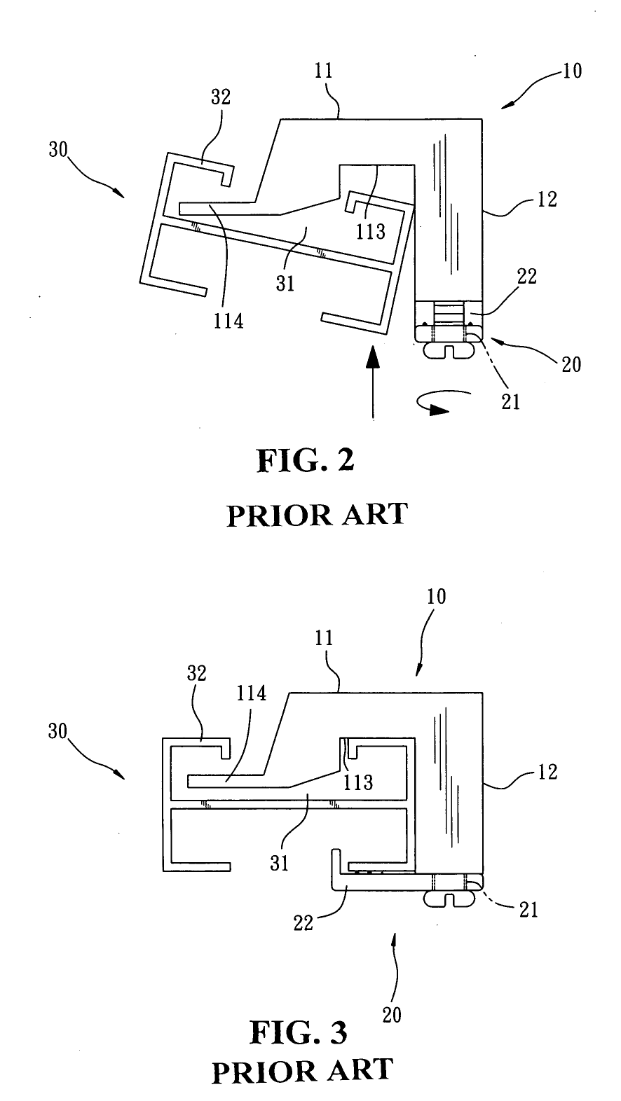

### DETAILED DESCRIPTION OF THE PREFERRED EMBODIMENTS

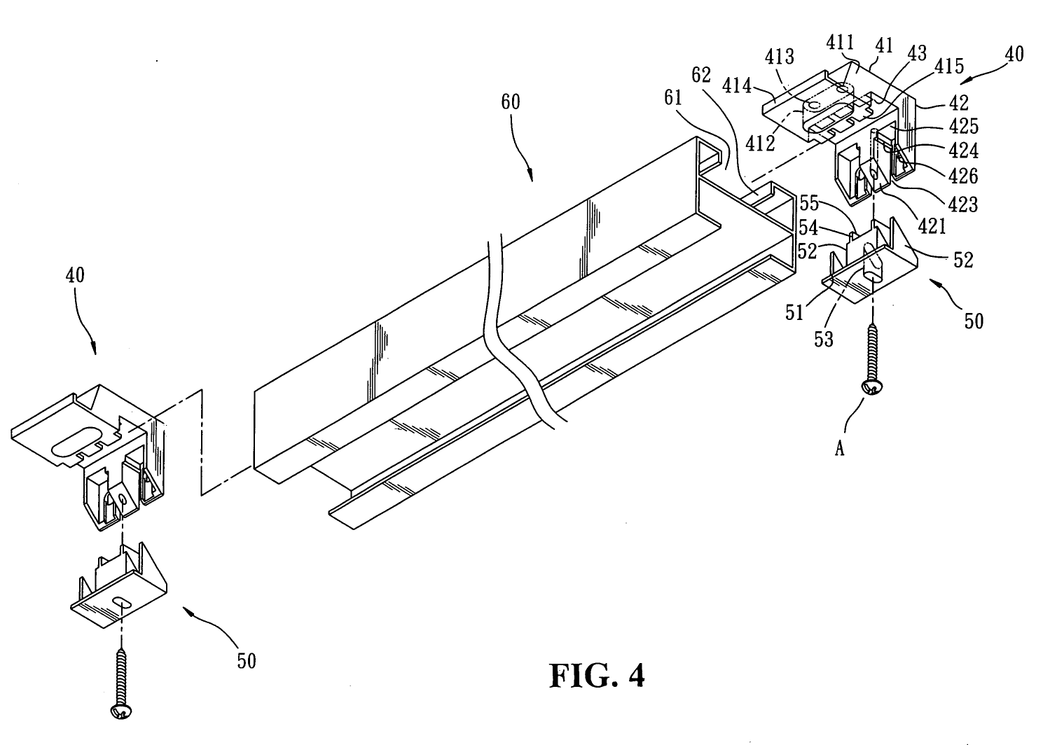

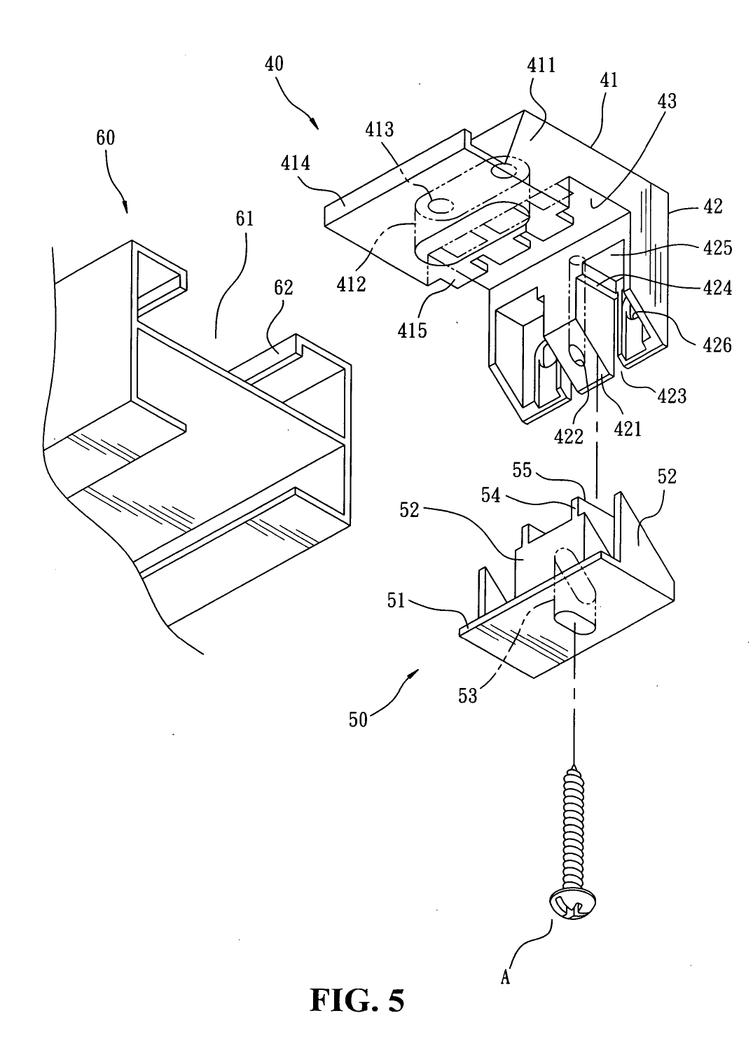

Please refer to FIG. 4 showing an exploded perspective view of the present invention (accompanied by FIG. 5). The present invention is related to a support bracket assembly for the headrail of window blinds, comprising a support bracket 40 and a clamping body 50 wherein the support bracket 40, molded in an inverted L-shaped configuration, is made up of a horizontal abutment surface 41 and a vertical abutment surface 42. A support seat 411 defined by a clearance groove 412 therein extends downwards at one side of the inner wall of the horizontal abutment surface 41, and a set of vertical fixing holes 413 is disposed extending through both inner lateral sides of the clearance groove 412 therein. The support seat 411 has an L-shaped retaining board 414 extending transversely at one end of the bottom side to fit to a conjoining portion 62 and a receiving groove 61 of a heardrail 60 thereby, and multiple support plates 415 extending in even spacing at the opposite side of the retaining board 414 thereof. At one side of the support seat 411 corresponding to that of the vertical abutment surface 42 thereof is preset an accommodation space 43 positioned higher than the retaining board 414 thereof. The vertical abutment surface 42 has a diagonal-shaped slant-cut facet 421 obliquely cut at the bottom side thereon, and an assembly hole 422 extending upwards in the middle section of the slant-cut facet 421 thereof for the registration of a locking element A therewith. A set of guide recesses 423 each having a stop end 424 cut at one edge thereon is provided symmetrically extending upwards to define both sidewalls of the assembly hole 422 thereby. The vertical abutment surface 42 is also equipped with a set of clearance cavities 425 each having a transverse fixing hole 426 symmetrically indented at both sides of the inner wall thereon. The clamping body 50 has a clamping board 51 protruding horizontally at the bottom edge thereon, and a plurality of trapezoidal-shaped oblique guide blocks 52 of different thickness extending vertically upwards to match with the slant-cut facet 421 of the support bracket 40 thereby. An oval-shaped limiting slot 53 is disposed extending through the center of the middle guide block 52 thereof, and a pair of pivoting guide plates 54 each having a horizontal stop plane 55 defining thereon is symmetrically provided extending upwards from both side of the limiting slot 53 on top of the middle guide block 52 thereof.

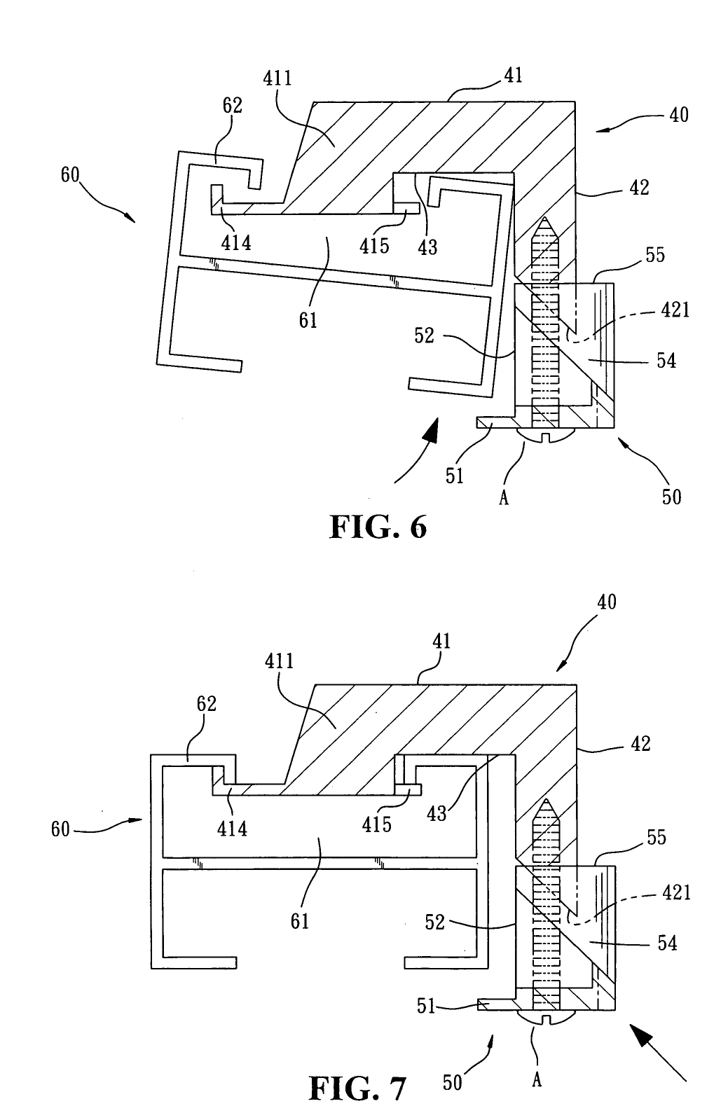

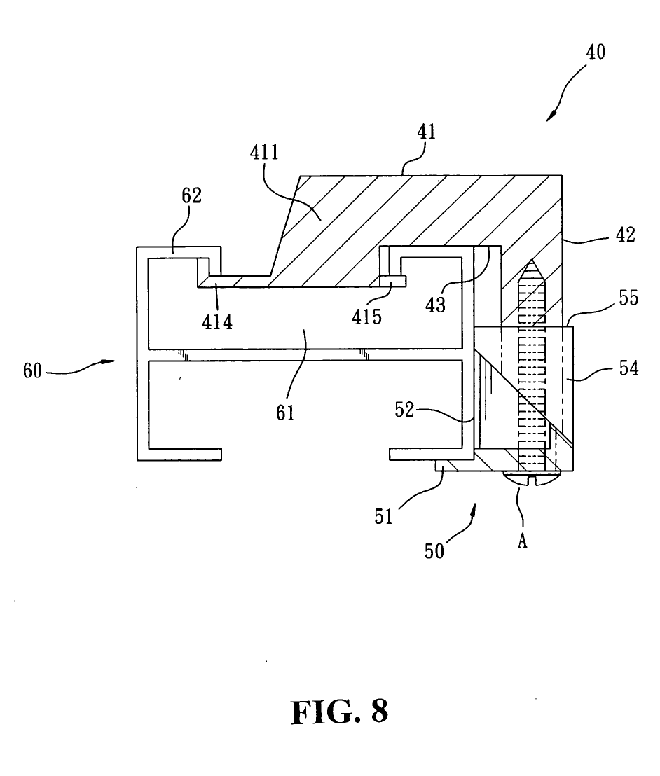

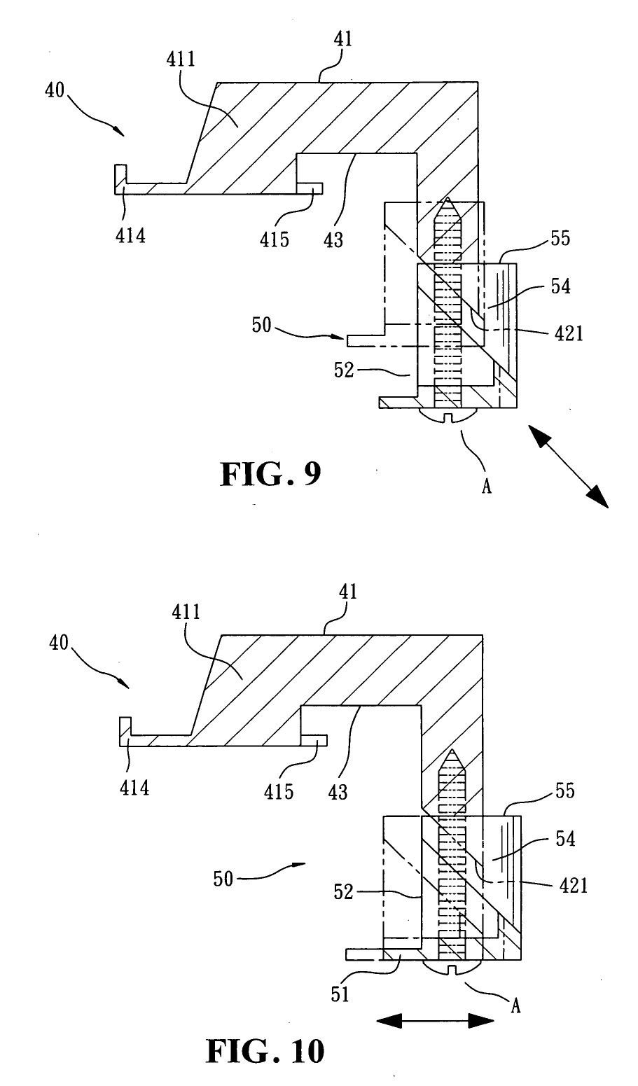

In assembly, via the horizontal abutment surface 41 and the vertical abutment surface 42 of the support bracket 40, the vertical or the transverse fixing holes 413, 426, depending on the circumstance of assembly, can be optionally selected and securely locked onto to a wall surface, permitting the fixing means applied thereto to precisely conceal in the clearance groove 412 or the clearance cavities 425 thereof. The headrail 60 as shown in FIG. 6 is then tilted to one side so that the support seat 411 can be completely mounted into the receiving groove 61 thereof, permitting the conjoining portions 62 symmetrically extending at both top upper longitudinal sides of the headrail 60 to precisely place onto the retaining board 414 and the support plates 415 thereof respectively and abut against the accommodation space 43 therein to form a support effect thereby. Then, the headrail 60 is moved to one side till the conjoining portion 62 and the retaining board 414 are evenly contacted and abutted against each other, permitting the headrail 60 to completely hang onto the support bracket 40 by itself for the easy assembly of the clamping body 50 onto the support bracket 40, omitting the inconvenient operation of the conventional support bracket wherein the headrail must be continuously held by a hand for the assembly thereof. Then, the locking element A is guided to the limiting slot 53 of the clamping body 50 and secured to the assembly hole 422 of the support bracket 40, permitting the pivoting guide plates 54 to accurately run through the guide recesses 423 respectively. The locking element A is then secured upwards to allow the slant-cut facet 421 and the oblique guide blocks 52 correspondingly engaged with each other. And, depending on the size of the headrail 60, the slant-cut facet 421 of the support bracket 40 can cooperatively operate with the limiting slot 53 of the clamping body 50 to form an adjustment space, permitting the clamping body 50 to move up/down as shown in FIG. 9 and forwards/backwards as shown in FIG. 10. Therefore, the clamping board 51 of the clamping body 50 can precisely contact and abut against the bottom surface of the headrail 60 to complete the assembly as shown in FIG. 8 wherein the stop ends 424 and the stop planes 55 are evenly contacted with each other so that the headrail 60 is maintained in a horizontally abutted state thereby. Thus, the present invention can provide flexible options in assembly to facilitate the versatility thereof, and boost the economical value to achieve the best state of application thereof.

What is claimed is:

1. A support bracket assembly for the headrail of window blinds, comprising a support bracket and a clamping body wherein the support bracket is made up of a horizontal abutment surface and a vertical abutment surface; the present invention being characterized by that,
the support bracket being equipped with a support seat that, extending downwards at one side of the horizontal abutment surface thereof, has a clearance groove defining therein, and a set of vertical fixing holes symmetrically extending through the clearance groove therein; both lateral bottom edges of the support seat are respectively disposed a retaining board and multiple support plates, and at one side of the support seat corresponding to that of the vertical abutment surface thereof is preset an accommodation space positioned higher than the retaining board thereof;
the vertical abutment surface being provided with a slant-cut facet obliquely cut at the bottom edge thereon, and an assembly hole extending upwards in the middle section of the slant-cut facet; a set of guide recesses each having a stop end cut at one edge is provided symmetrically defining both sidewalls of the assembly hole thereby; the vertical abutment surface also including a set of clearance cavities each having a transverse fixing hole symmetrically indented at both sides of the inner wall thereon;
the clamping body being made up of a clamping board protruding horizontally at the bottom edge thereon, and multiple oblique guide blocks extending vertically upwards at the other side thereof; a limiting slot is disposed extending through the center of the middle guide block thereon, and a pair of pivoting guide plates each having a horizontal stop plane defining thereon is disposed extending symmetrically upwards at both sides of the limiting slot on top of the middle guide block thereof;
therefore, the guide recesses of support bracket is matched to the pivoting guide plates of the clamping body and a locking element is registered with the limiting slot of the clamping body; and via the design of the slant-cut facet cooperatively matched with the oblique guide blocks thereof, the support bracket assembly can be appropriately adjusted upwards/downwards and forwards/backwards to fit to headrails of different sizes for stable location of the headrails thereby, flexibly expanding the range of application and boosting the versatility thereof.

2. The support bracket assembly for the headrail of window blinds as claimed in claim 1 wherein the retaining board of the support bracket is molded in an L-shaped configuration.

3. The support bracket assembly for the headrail of window blinds as claimed in claim 1 wherein the support plates of the support bracket are multiple and evenly arranged in equal spacing.

4. The support bracket assembly for the headrail of window blinds as claimed in claim 1 wherein the slant-cut facet of the support bracket is obliquely cut in a diagonal configuration.

5. The support bracket assembly for the headrail of window blinds as claimed in claim 1 wherein the oblique guide blocks of the clamping body are shaped in a trapezoidal configuration with different thickness, and are correspondingly matched to the slant-cut facet of the support bracket thereof.

6. The support bracket assembly for the headrail of window blinds as claimed in claim 1 wherein the limiting slot of the clamping body is made in an oval shape.
